(19) United States
(12) Patent Application Publication
(10) Pub. No.: US 2008/0292827 A1
(43) Pub. Date: Nov. 27, 2008

(54) CAR MAT MODULE

(76) Inventor: Jae Yong Lee, Ansan-si (KR)

Correspondence Address: MORGAN, LEWIS & BOCKIUS LLP (SF), One Market, Spear Street Tower, Suite 2800, San Francisco, CA, 94105, US

(21) Appl. No.: 11/942,477

(22) Filed: Nov. 19, 2007

(30) Foreign Application Priority Data
May 23, 2007 (KR) 10-2007-0050240

(51) Int. Cl. B32B 3/26

(52) U.S. Cl. 428/63

(57) ABSTRACT

A car mat module includes a floor carpet with at least one depression, and at least one car mat configured and dimensioned to be seated into the depression. The thickness of the depression may be substantially equal to the thickness of the car mat. The depression may include at least one slot and the car mat may include at least one protrusion configured and dimensioned to be inserted into the slot. At least one hook may be provided on the car mat or the floor carpet, configured to secure the floor mat and the carpet together. The at least one slot may be two slots disposed along opposite edges of the depression. Each protrusion may be a plurality of co-linear protrusions disposed along a single edge of the car mat, and each slot may be a plurality of co-linear slots disposed along a single edge of the depression.

### CROSS-REFERENCE TO RELATED APPLICATIONS

This application claims priority to Korean Application No. 10-2007-0050240, filed on May 23, 2007, the disclosure of which is incorporated herein by reference.

### BACKGROUND OF THE INVENTION

1. Field of the Invention

The present invention relates generally to car mat module and, more particularly, to a car mat module with depressions in the floor carpet, such that car mats are seated into the respective depression parts.

2. Description of the Related Art

Generally, floor carpets are laid on the floors in the cars, and car mats are placed on the floor carpets. Various floor carpets and car mats with structures such that the car mats are prevented from being undesirably moved relative to the floor carpets have been proposed. For example, hooks are sometimes used to fasten the car mat to the floor carpet. However, the car mat protrudes from the upper surface of the floor carpet, which is not aesthetically pleasing. In addition, if the number of hooks for holding the car mat is insufficient, the car mat may undesirably move with respect to the floor carpet.

### SUMMARY OF THE INVENTION

A car mat module includes a floor carpet with at least one depression, and at least one car mat configured and dimensioned to be seated into the depression. The thickness of the depression may be substantially equal to the thickness of the car mat. The depression may include at least one slot and the car mat may include at least one protrusion configured and dimensioned to be inserted into the slot. At least one hook may be provided on the car mat or the floor carpet, configured to secure the floor mat and the carpet together. The at least one slot may be two slots disposed along opposite edges of the depression. Each protrusion may be a plurality of co-linear protrusions disposed along a single edge of the car mat, and each slot may be a plurality of co-linear slots disposed along a single edge of the depression.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a floor carpet according to a first embodiment of the present invention;

FIG. 2 is a perspective view showing the assembly of a car mat module according to the first embodiment of the present invention;

FIG. 3 is a sectional view showing the car mat module of FIG. 2;

FIG. 4 is a perspective view showing the assembly of a car mat module, according to a second embodiment of the present invention;

FIG. 5 is a sectional view showing the car mat module of FIG. 4;

FIG. 6 is a perspective view showing the assembly of a car mat module, according to a third embodiment of the present invention; and

FIG. 7 is a perspective view showing the assembly of a car mat module, according to a fourth embodiment of the present invention.

### DESCRIPTION OF THE PREFERRED EMBODIMENTS

Hereinafter, preferred embodiments of the present invention will be described in detail with reference to the attached drawings.

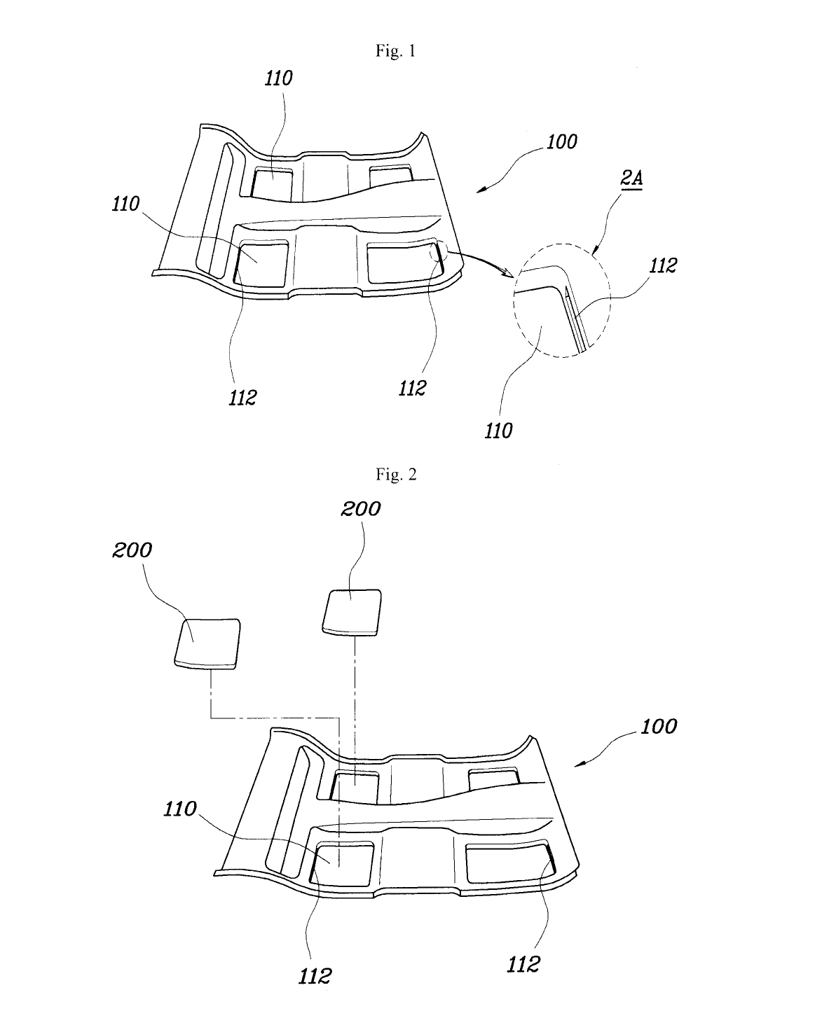

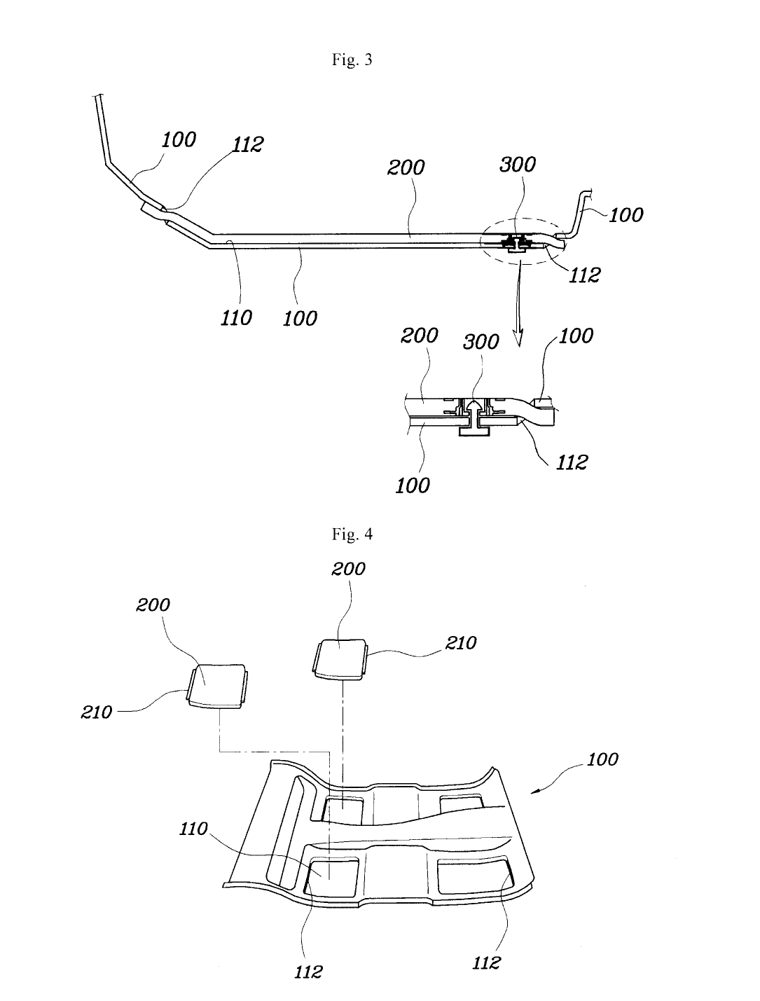

As shown in FIGS. 1 through 3, an exemplary car mat module allows the upper surfaces of car mats to be substantially level with the upper surface of the floor carpet 100, which is provided on the floor in the car. In particular, depression parts 110, each of which has insert slots 112 therein, are provided in the floor carpet 100, and each mat 200 is seated into a corresponding depression part 110 such that edges of the car mat 200 are inserted into the corresponding insert slots 112.

The depression parts 110 are concave. Four depression parts 110 may be provided. Each mat 200 is seated into the corresponding depression part 110. Preferably, the upper surface of the car mat 200 is substantially at the same level as the upper surface of the floor carpet 100, particularly at the junction therebetween. Therefore, in some embodiments, the depth of each depression part 110 is substantially equal to the thickness of the corresponding mat 200.

Thereby, the feet of the passenger are prevented from being caught at the junction between the car mat 200 and the floor carpet 100. Furthermore, the ease of assembly of the car mat 200 with the floor carpet 100 is enhanced, and the external appearance is superior.

Furthermore, as shown in the enlarged circled portion 2A of FIG. 1, in some embodiments, the insert slots 112 are disposed at the edges of the depression part 110, such as at the front and rear edges. The corresponding edges of the car mat 200 are inserted into the respective insert slots 112.

Further, hooks 300 may be provided between the floor carpet 100 and the car mat 200. The hooks 300 may be provided at the front and/or rear edges of the car mat 200.

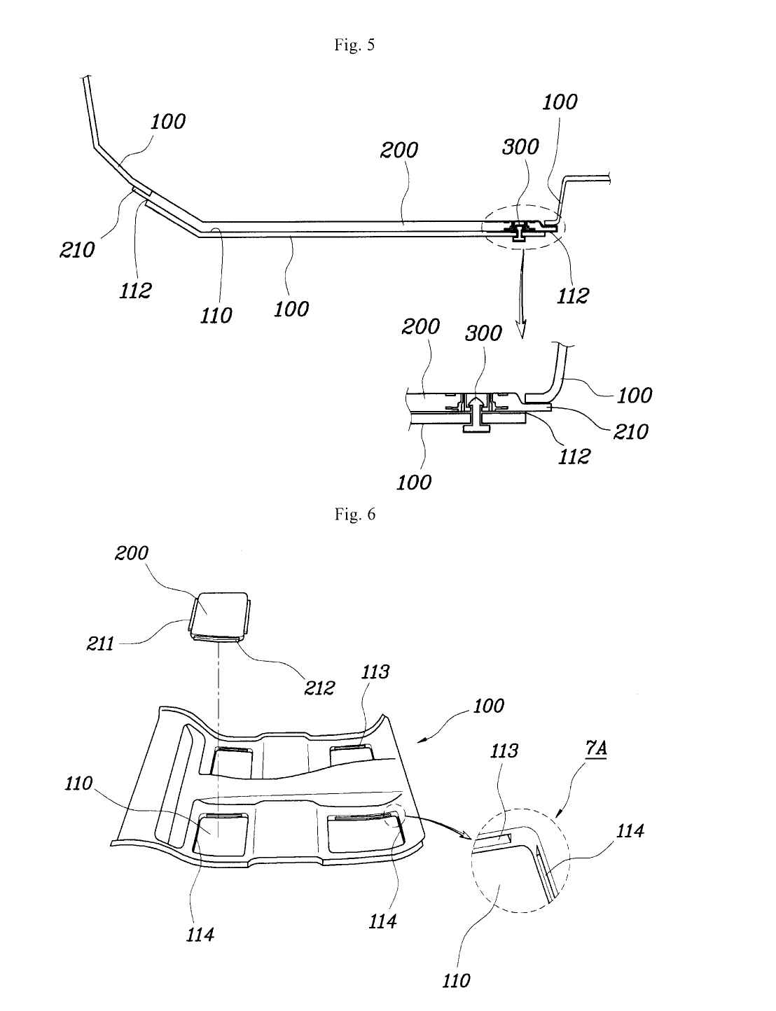

As shown in FIGS. 4 and 5, in a second embodiment, insert protrusions 210 are provided at in some edges of each mat 200, and are inserted into respective insert slots 112 of a corresponding depression part 110 of the floor carpet 100. The insert protrusions 210 are provided at each of the associated edges of the car mat 200 that correspond to each insert slot 112.

In some embodiments, in addition to the insert protrusions 210, hooks 300 are provided. The hooks 300 may be provided around the front and/or rear edges of the car mat 200.

While the insert slots 112 have been described and illustrated as being provided at the front and rear edges of each depression part 110 for simplicity, the present invention is not limited thereto. That is, the insert slots may be provided at the side edges of each depression part 110, or at any other appropriate location.

In a third embodiment, as shown in FIG. 6, and referring particularly to the enlarged circled portion 7A of FIG. 6, side insert slots 113 and/or front and rear insert slots 114 may be provided at edges of the depression part 110. Furthermore, side insert protrusions 212, corresponding to the side insert slots 113, are provided at the side edges of the car mat 200, and/or front and rear insert protrusions 211, corresponding to the front and rear insert slots 114, are provided at the front and rear edges of the car mat 200.

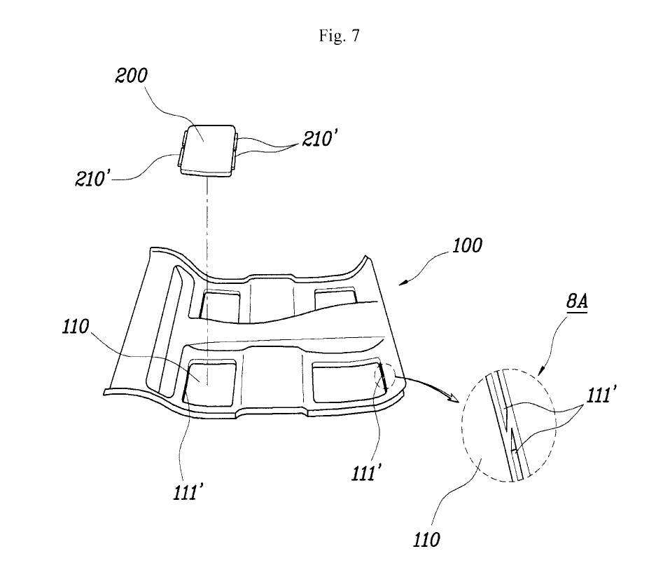

In a fourth embodiment, as shown in FIG. 7, insert protrusions 210′ are provided at some of the edges of each mat 200. Furthermore, insert slots 111′ are provided at corresponding edges of each depression part 110. The insert protrusions 210′ and insert slots 111′ are discontinuous.

To assemble the above-described module, the edges of each mat 200 are inserted into the respective insert slots 112 of the corresponding depression part 110. Thereafter, the car mat 200 is fastened to the floor carpet 100 using the hooks 300.

Therefore, each mat 200 is reliably seated into and fastened to the corresponding depression part 110. Furthermore, the junction parts between the upper surface of the car mat 200 and the upper surface of the floor carpet 100 are level with each other. The ease of assembly between the floor carpet 100 and the car mat 200 is enhanced. Furthermore, because the car mats 200 are provided on the floor carpet 100 only at the positions at which the feet of passengers are placed, the manufacturing cost is reduced. Moreover, the appearance is superior and the coupling force between the car mat and the floor carpet is sufficient.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A car mat module, comprising:
a floor carpet comprising at least one depression; and
at least one car mat configured and dimensioned to be seated into the depression.

2. The car mat module as set forth in claim 1, wherein a thickness of the depression is substantially equal to a thickness of the car mat.

3. The car mat module as set forth in claim 1, wherein the depression comprises at least one slot and the car mat comprises at least one protrusion configured and dimensioned to be inserted into the slot.

4. The car mat module as set forth in claim 1, further comprising at least one hook on the car mat or the floor carpet, configured to secure the floor mat and the carpet together.

5. The car mat module as set forth in claim 3, wherein the at least one slot comprises two slots disposed along opposite edges of the depression.

6. The car mat module as set forth in claim 3, wherein the protrusion comprises a plurality of protrusions disposed along a single edge of the car mat, and the slot comprises a plurality of slots disposed along a single edge of the depression.

7. The car mat module as set forth in claim 6, wherein the plurality of protrusions are substantially co-linear, and the plurality of slots are substantially co-linear.
